(19) United States
(12) Patent Application Publication
(10) Pub. No.: US 2009/0301918 A1
(43) Pub. Date: Dec. 10, 2009

(54) Wainscot panel packaging with indicator

(76) Inventor: Martin Steinwender, Perchtoldsdorf (AT)

Correspondence Address: PROSKAUER ROSE LLP, ONE INTERNATIONAL PLACE, BOSTON, MA, 02110, US

(21) Appl. No.: 12/299,078

(22) PCT Filed: Apr. 24, 2007
(86) PCT No.: PCT/EP2007/053987

§ 371 Date: Dec. 4, 2008

(30) Foreign Application Priority Data
May 2, 2006 (DE) 10 2006 020 619.3

(51) Int. Cl. B65D 79/02; G01L 5/00; G01D 21/00

(52) U.S. Cl. 206/459.1; 116/212

(57) ABSTRACT

Panel packaging includes a wrapper, comprising at least one panel received by the wrapper and at least one indicator for displaying at least one stress. The indicator alters its appearance at least once depending on the at least one stress. The panel packaging provides improved handling of the panel by including at least one indicator for displaying at least one stress.

### CROSS-REFERENCE TO RELATED APPLICATIONS

This application is a National Phase Application of International Application No. PCT/EP2007/053987, filed on Apr. 24, 2007, which claims the benefit of and priority to German Patent Application No. DE 10 2006 020 619.3, filed on May 2, 2006. The disclosure of the above applications are incorporated herein by reference in their entirety.

### FIELD OF THE INVENTION

The invention relates to panel packaging comprising a wrapper and comprising at least one panel received by the wrapper.

### BACKGROUND OF THE INVENTION

Panel packaging has been known for a long time. In this connection, many different embodiments are selected regarding the materials, size, geometric shape and visual design of the wrappers. In particular, wrappers made of cardboard material may be produced by which one or more panels are received.

It is further known to package panels using wrappers made of packaging films. Also, a combination of cardboard packaging as well as packaging film is known sufficiently from the prior art.

In the known panel packaging it is a drawback that the handling of the panel packaging and/or the panels is made more difficult by limited information.

Firstly, only a small amount of information about the panel packaging and/or the panels is available to the installer and/or the end user after delivery. Even for the manufacturer, the known panel packaging has these drawbacks because as soon as the panel packaging is outside the manufacturer's control, the manufacturer is not able to obtain information—apart from the current storage position—about the panel packaging and/or the panels. In particular, no panel packaging is known which is able to provide information individually, i.e. respectively about the panel packaging itself.

Additionally, floors are known from WO 00/75417 and WO 03/038777 in which sensors are provided which are able to transmit a stress applied to the floor to a data processing system. The transmission may in this case be carried out by fixed electrical connections or via radio. In the installed state, such floors are used for analyzing stresses and for controlling specific conditions depending on the stresses. For example, a floor may be produced which, when trodden upon, triggers an alarm or controls an air-conditioning unit. In the known floors it is a drawback that the sensors are costly to produce and further devices are required for evaluating the sensors.

### SUMMARY OF THE INVENTION

The technical problem of an aspect of the invention, therefore, is to improve and to facilitate the handling of panel packaging by a greater provision of information.

The technical problem disclosed above is achieved according to an embodiment of the invention by panel packaging comprising at least one indicator for displaying at least one stress, the indicator being attached to at least one fastening element, the indicator altering its appearance at least once depending on the at least one stress, and at least one indicator being designed such that maintaining preconditioning at a temperature of between about 15° C. and 20° C. and air humidity of between about 30% and 80% may be read over a specific time period.

The invention has thus identified that by providing an indicator there is the possibility of reading information about a stress directly, in particular with the naked eye and without further aids, individually on the panel packaging.

All indicators which are used, for example, in salts and which are used for drying, are suitable as indicators in order to indicate whether the salts have already absorbed water or whether they may still be used for drying.

An alteration to the appearance may be made possible by altering the color of the indicator. Moreover, the indicator may comprise different fields which, for example, may adopt two different states. Thus an alteration to the appearance may be an alteration to the number of fields of the same state.

As the indicator may be designed, in particular, so that it only alters its appearance once, panel packaging is provided with an indicator which may store a stress which has occurred once. This embodiment is suitable, in particular, for explaining the occurrence of damage, as the indicator may serve as proof that predetermined thresholds have been exceeded or fallen below.

The aforementioned technical problem, irrespective of the packaging of the panels, is solved by a panel comprising an aforementioned indicator, the indicator being attached to at least one fastening element. The indicator is disclosed hereinafter in more detail, the disclosed invention being able to be used whether it refers to panel packaging with an indicator or a panel with an indicator.

It may further be provided that the indicator alters its appearance repeatedly, in particular continuously, depending on the at least one stress. Thus at any time it may be established in what state the panel packaging and/or the panels are at a given time. Depending on this state, decisions may be made relative to the ability to install the panels, and the handling of the panel packaging and/or the panels may be considerably simplified.

In this case, the at least one stress may be a stress caused by temperature and/or humidity. Thus falling below and/or exceeding climatic thresholds relative to the permissible temperature and/or humidity during transportation may be made visible. In particular, this may be very advantageous in container transportation over long distances.

The indicator may display whether installation requirements have been followed. It may be designed such that it may be read on said indicator whether the panel packaging has been preconditioned, for example between about 15° C. and 20° C., in particular at 18° C. or greater and between about 30% and 80%, in particular between 40% to 70%, air humidity, over a specific time period of days, in particular 24 or 48 hours.

Moreover, an indicator may be provided which may display stress caused by mechanical strain. For example, such an indicator may be discolored in the event of too great a loading of the panel packaging. Also such an indicator may be designed as an encapsulated system and may be provided on one or all panels. In the event of too great a loading the capsules release a dye. Thus the slightest damage to the panels, for example to the edge regions, may be made visible and the installer may use the appropriate panels for installing in the edge regions as well as by cutting off the damaged edges.

Alternatively, the at least one stress may be a stress caused by light. Thus it may be read on the indicator whether the panel packaging and, in particular, a panel has been subjected to too great a stress by light. As a result, it may be prevented that, for example, bleaching of the decorative design of a panel is only established after installation.

Particularly advantageously, the indicator may be attached to at least one fastening element.

In this case, the at least one fastening element may be packaging film of the wrapper. When the indicator is applied externally onto the panel packaging, it may be used for displaying the loads which act from outside on the panel packaging. Thus an indicator may also be provided on the outside of the base of the panel packaging. If the panel packaging is thus left for a specific time on the floor, on which the panels are intended to be installed, subsequently it may be read using the indicator whether the floor has the necessary degree of dryness.

If the indicator or a further indicator is attached to the inside of the packaging film, the stress may be displayed after opening the panel packaging. A plurality of indicators may also be provided, for example on the outer face and inner face of the packaging film. Thus a conditioning of the sealed panel packaging in the area in which the panels are intended to be installed may be read on the attached indicators. It may thus be prescribed that opening the panel packaging and subsequent installation is only permitted after matching the indicators.

Also, the at least one fastening element may be cardboard packaging. This is particularly advantageous when using panel packaging which consists of packaging film and cardboard packaging, as after removing the packaging film the panels may remain in the cardboard packaging for conditioning, the state of the panels being able to be displayed directly on the cardboard packaging by the indicator.

Moreover, the at least one fastening element may be a panel. Thus for example on each panel it may be individually displayed which stresses it has been subjected to or is subjected to. In particular, installing a panel in the incorrectly conditioned state and/or on a substrate which is too damp is displayed. Also, an unauthorized external application of excessive moisture, for example by using too much cleaning fluid, may be displayed by this indicator.

A cost-effective possibility is when the at least one fastening element is an insert and/or a label. Thus the indicators may be mass-produced and inserted into the panel packaging and/or fastened to the panel packaging and/or panels.

If a panel has impact sound insulating material, this may also be used as a fastening element.

One embodiment is characterized in that the indicator has a cover. In particular, it may be a cover deactivating the indicator. The indicator is adapted to the ambient conditions only after the cover has been removed. Thus an indicator could be provided on the inner face of the packaging film, which is deactivated by additional cardboard packaging of the panels or by a panel itself. The indicator may thus be “programmed” so that when opening the panel packaging, and thus activating the indicator by removing the cover, the indicator is permanently discolored beyond a specific temperature difference and/or humidity difference between the indicator and the ambient air, and thus may be used as proof of insufficient conditioning of the panels. In contrast, the indicator may be arranged on the lowest panel in the panel packaging and the cover attached to the panel packaging, for example attached to packaging film or cardboard packaging, so that when removing the last panel the cover exposes the indicator and as explained above may accordingly display stresses.

In an embodiment, it is particularly preferred if at least one scale is provided explaining the appearance of the indicator. A scale may in this case be provided directly in the vicinity of the indicator. For example, a scale may be provided on the outside and/or inside of the packaging film. It may be a comparison scale which explains specific colors and their meaning relative to the temperature and/or humidity of the indicator. The scale may be printed on.

It is also possible to print an indicator on the fastening element. Thus by means of a flexible production process, according to requirements, panel packaging may be provided with an indicator.

The same indicators may be used with the same or different scales. For example, the same indicator may be provided on the base and on the side of the panel packaging. On the base, a “floor conditions” scale could be attached, and on the side an “ambient conditions” scale could be attached. Also, different indicators could be provided according to the function. In particular, the composition of the indicator may be adapted to the respective state to be displayed.

The stresses to be displayed, for example for an installer and/or during installation, by in particular continuous alteration of the appearance of the indicator, may in this case indirectly serve to display further states of the panels.

As a result of an appropriate design, an indicator may be used which displays a stress or a combination of stresses due to temperature and/or humidity and/or mechanical stress, to provide information about the risk of peaking (lifting of edges), distortion, buckling, longitudinal expansion, warping, lateral bending problems or other problems, which may occur as a result of insufficient conditioning of the panels located in the panel packaging. In this case the indicator, as already mentioned, may be provided on the panel packaging and/or the panels, according to requirements.

The stresses which may be displayed, for example, for the manufacturer and/or for the production process as a result of, in particular, a single alteration to the appearance of the indicator, may be used indirectly to display further states of the panels. Particularly advantageously, proof may be provided in this manner for the possible processing of claims.

The stresses to be established indirectly might be listed, but not exhaustively, as: excessively damp substrate, excessively damp transportation, excessively high inlet temperature for underfloor heating, excessively damp/dry ambient conditions, excessively wet cleaning or water damage as well as mechanical damage by the end user.

### BRIEF DESCRIPTION OF THE DRAWINGS

The present invention is intended to be described in more detail hereinafter with reference to specific embodiments as well as the accompanying drawings, in which:

FIG. 1 shows panel packaging comprising an indicator fastened to the packaging film,

FIG. 2 shows opened panel packaging comprising an indicator fastened to the packaging film, and an indicator fastened to the cardboard packaging, respectively with an explanatory scale and

FIG. 3 shows panel packaging comprising an indicator fastened to the cardboard packaging as well as an indicator fastened to a panel.

### DESCRIPTION

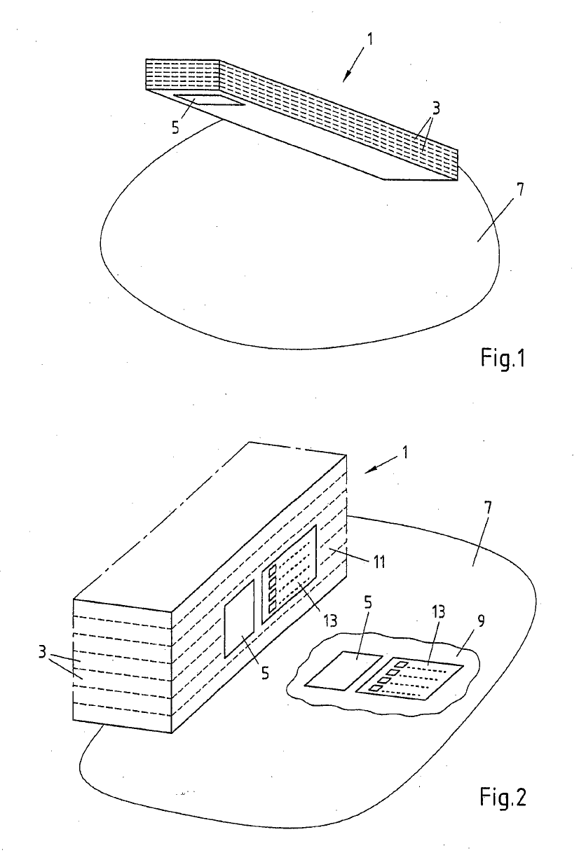

FIG. 1 shows panel packaging 1 comprising a plurality of panels 3 received by the panel packaging 1 and with an indicator 5 for displaying a stress caused by temperature or humidity, the indicator 5 altering its appearance once, depending on the stress. In this case, the wrapper of the panel packaging may consist of packaging film.

Such an embodiment is particularly suitable for displaying when reliable thresholds may be fallen below or exceeded. If the humidity, for example, has not been between 30% and 80%, in particular between 40% to 70%, during transportation the indicator 5 could permanently discolor red and thus indicate the unusability of the panels 3 and at the same time exclude claims as the transportation requirements have not been maintained.

Alternatively, the indicator 5 may be provided for resting against a floor 7. By leaving the panel packaging 1 on the floor 7 for a prescribed time period the indicator 5 may be used to provide information about the dryness of the floor 7.

FIG. 2 shows opened panel packaging 1, comprising panels 3. In the embodiment shown in FIG. 2, the wrapper is formed from packaging film 9 and cardboard packaging 11. Before the packaging film 9 was opened, the cardboard packaging 11 had been enclosed by the packaging film 9. The packaging film 9, as well as the cardboard packaging 11, respectively comprise indicators 5 and one respective scale 13 explaining an indicator 5.

The scale 13 may, for example, have four fields of different colors. Additionally, in the vicinity of each field a text is provided explaining the color.

The embodiment shown in FIG. 2 may be used so that initially the panel packaging 1 is preconditioned in the sealed state over a specific time period of days, in particular 24 or 48 hours. In this case, the indicator 5 attached to the packaging film 9—which is attached to the surface of the packaging film 9 oriented outwardly in the packed state—adopts a particular color which is explained on the scale 13 as suitable for installation.

It may be prescribed that opening the panel packaging 1 and installing the panels 3 is not able to take place before the two indicators 5 match. Thus it may be ensured that the panels 3 have been able to be adapted for a sufficiently long period of time to the ambient conditions.

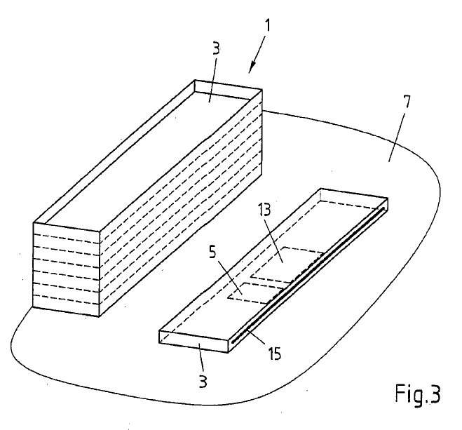

FIG. 3 shows opened panel packaging 1, from which one panel 3 has been removed. The panel 3 has an indicator 5 on its underside. In particular, the indicator 5 may be fastened to impact sound insulation. Additionally an indicator 15 may be provided on the longitudinal edges of the panel 3. The indicator 5 may, as explained before, be used for displaying the humidity of the floor 7. One part of the scale 13 which is also provided in FIG. 3 on the underside of the panel 3, is used for explaining the indicator 5.

The indicator 15 may be designed to be encapsulated so that in the event of too great a mechanical stress on the longitudinal edges, it is discolored, as explained on the scale 13.

Also, the indicator 15 may be designed such that by altering its appearance it may display peaking of the longitudinal edges or a distortion of the panel 3.

The invention is not restricted to the aforementioned embodiments. Other embodiments are possible. For example, the indicator may be connected to an insert or label. The indicator may be provided by printing on the panel packaging and/or one or more panels.

Additionally, a cover may be provided for the indicator.

1. Panel packaging
comprising a wrapper,
comprising at least one panel received by the wrapper and
comprising at least one indicator for displaying at least one stress,
the indicator being attached to at least one fastening element and
the at least one indicator altering its appearance at least once depending on the at least one stress, wherein
at least one indicator is designed such that maintaining preconditioning at a temperature of between about 15° C. and 20° C. and air humidity of between about 30% and 80% may be read over a specific time period.

2. Panel packaging according to claim 1,
wherein the at least one indicator alters its appearance repeatedly depending on the at least one stress.

3. Panel packaging according to claim 1,
wherein the at least one stress is a stress caused by temperature.

4. Panel packaging according to claim 1, wherein
the at least one stress is a stress caused by humidity.

5. Panel packaging according to claim 1, wherein
the at least one stress is a stress caused by mechanical strain.

6. Panel packaging according to claim 1, wherein
the at least one stress is a stress caused by light.

7. (canceled)

8. Panel packaging according to claim 1, wherein
the at least one fastening element is packaging film.

9. Panel packaging according to claim 1, wherein
the at least one fastening element is cardboard packaging.

10. Panel packaging according to claim 1, wherein
the at least one fastening element is a panel.

11. Panel packaging according to claim 1, wherein
the at least one fastening element is an insert.

12. Panel packaging according to claim 1, wherein
the at least one fastening element is a label.

13. Panel packaging according to claim 1, wherein
the at least one fastening element is impact sound insulating material.

14. Panel packaging according to claim 1, wherein
the at least one indicator has a cover.

15. Panel packaging according to claim 1, wherein
at least one scale is provided explaining the appearance of the at least one indicator.

16. Panel packaging according to claim 1, wherein
the at least one indicator is printed on the fastening element.

17. Panel,
comprising at least one indicator for displaying at least one stress,
the at least one indicator being attached to at least one fastening element and
the at least one indicator altering its appearance at least once depending on the at least one stress, wherein
at least one indicator is designed such that maintaining preconditioning at a temperature of between about 15° C. and 20° C. and air humidity of between about 30% and 80% may be read over a specific time period.

18. (canceled)

19. Panel according to claim 17, wherein
the at least one indicator alters its appearance repeatedly depending on the at least one stress.

20. Panel according to claim 17, wherein
the at least one stress is a stress caused by temperature.

21. Panel according to claim 17, wherein
the at least one stress is a stress caused by humidity.

22. Panel according to claim 17, wherein
the at least one stress is a stress caused by mechanical strain.

23. Panel according to claim 17, wherein
the at least one stress is a stress caused by light.

24. Panel according to claim 17, wherein
the at least one fastening element is a panel.

25. Panel according to claim 17, wherein
the at least one fastening element is a label.

26. Panel packaging according to claim 17, wherein
the at least one fastening element is impact sound insulating material.

27. Panel according to claim 17, wherein
the at least one indicator has a cover.

28. Panel according to claim 17, wherein
at least one scale is provided explaining the appearance of the at least one indicator.

29. Panel according to claim 17, wherein
the at least one indicator is printed on the fastening element.
